(19) United States
(12) Patent Application Publication
(10) Pub. No.: US 2026/0359450 A1
(43) Pub. Date: Nov. 12, 2026

(54) SYSTEM AND METHODS FOR THREAT-AWARE KEY AND CIPHER ROTATION

(71) Applicant: Quiot Security, Portola Valley, CA (US)

(72) Inventors: Ronald Joseph Kent, Keller, TX (US); Michael Reid Tennefoss, Portola Valley, CA (US)

(21) Appl. No.: 19/673,512

(22) Filed: May 11, 2026

Related U.S. Application Data
(60) Provisional application No. 63/804,448, filed on May 12, 2025.

(51) Int. Cl. G06F 21/57; H04L 9/08

(52) U.S. Cl. CPC G06F 21/577; H04L 9/0891

(57) ABSTRACT

A method and apparatus that implements cryptographic ciphers and key exchange mechanisms, selected from a pool of available ciphers and key mechanisms including but not limited to quantum-resistant ciphers and key mechanisms, which ciphers and keys are in response to the detection, notification, inferential determination, estimation, or prediction of an in-progress, imminent, emerging, and/or anticipated threat.

### CROSS-REFERENCE TO RELATED APPLICATIONS

This application claims the benefit of U.S. Provisional Patent Application No. 63/804,448, filed on May 12, 2025, which application is incorporated herein by reference.

This application is related to the following co-pending application filed on the same day as the present application: U.S. patent application Ser. No. 19/673,323, titled “Systems And Methods Of Network Security Playbook Creation And Utilization”, attorney docket no. 19822.00011 (1010US1), which application is incorporated herein by reference.

### FIELD OF INVENTION

This invention relates generally to securing automation systems and more particularly to applying threat-aware, quantum-resistant encryption with dynamic cipher and key rotation for use with information technology, operational technology, and Internet of Things networks and devices.

### BACKGROUND OF THE INVENTION

Asymmetric cryptography uses the public key from mathematically linked public-private-key pairs to encrypt, and the private key to decrypt, senders' and recipients' sensitive data. A key advantage of asymmetric encryption is the elimination of secure key exchanges, which is a point of vulnerability for symmetric encryption and an inconvenience for those using it. Users sharing data have unique public and private key pairs, and since the public keys are used only for encryption, the public keys can be widely shared without risking that messages can be decrypted so long as the private keys are kept secret. Asymmetric encryption can also be used for digital signature authentication, where a private key is used to digitally sign a file or message and the corresponding public key is used to verify the authenticity of the sender. These advantages have made asymmetric public key cryptography hugely popular for digital certificates, encrypted email, Web server access, secure messaging services, secure file transfer, virtual private network encryption, machine automation security, and a host of other applications.

Asymmetric cryptography—including RSA, Diffie-Hellman, and other algorithms based on elliptic curve or discrete logarithms—is vulnerable to attacks from large-scale quantum computers running Shor's algorithm. At risk are billions of Information Technology (IT), Operational Technology (OT), and Internet of Things (IoT) devices in government, industrial, commercial and consumer applications.

Many Symmetric algorithms are said to be resistant to attack from quantum computers, however, given the changing nature of cybersecurity algorithm agility, resiliency, and flexibility will be needed to protect sensitive infrastructure as quantum computer-based cyberattacks adapt over time.

It is not feasible to insert quantum-resistant encryption technology into devices and infrastructure that were not designed to be upgraded with quantum-resistant encryption technology because the required compute, real-time encryption, credential management, and memory resources are not available in many IT, OT, and IoT devices. Given the foregoing, a means is needed to remediate that susceptibility with (a) a quantum-resistant encryptor that is easily retrofitted to existing devices and network infrastructure, (b) methods that enable ciphers, key management, and other mechanisms to be updated as quantum cryptanalysis and cyberattacks evolve, and (c) a method to protect encryptor integrity against ransomware, insider attacks, phishing, and penetration attacks targeting key and cipher provisioning, selection, rotation, and updating mechanisms, the success of which could undermine the security benefits of using a quantum-resistant encryptor.

Manual and scheduled key rotation have been used for decades to confound cryptanalysis. By modifying the target encrypted stream sufficiently frequently, in theory, key rotation ensures that codebreaking attempts have to be restarted so often that the endeavor proves futile. Traditional rotation techniques, however, are poorly suited to a dynamic threat environment involving insiders and attacks that quicky propagate laterally. For example, scheduled key rotation may be ineffective against an insider with knowledge of the current key even when the insider's attempted penetration is quickly detected.

Ciphers are handled differently than keys, and once implemented, are typically left to run unchanged. Even if a better algorithm is developed, many encryptors cannot be updated in the field or at all. If the algorithm is compromised, or at risk of compromise, there is no real-time mechanism to rotate it to a new cipher.

The lack of dynamic, real-time safeguards to protect the integrity of ciphers and their keys is today being actively exploited by adversaries. The movement to quantum-resistant encryption will not by itself address that gap, the closing of which requires a means of adapting to changing threat environments.

### SUMMARY OF THE INVENTION

A method and apparatus that implements cryptographic ciphers and key exchange mechanisms, selected from a pool of available ciphers and key mechanisms including but not limited to quantum-resistant ciphers and key mechanisms, and which pool can be updated from time to time.

In an exemplary embodiment, the system provides a cipher and key rotation mechanism in which ciphers and/or keys can be changed (“rotated”) to a different cipher and/or key in response to the detection, notification, inferential determination, estimation, or prediction of an in-progress, imminent, emerging, and/or anticipated threat.

A method and apparatus of a system to change an algorithm for encryption is described. In an exemplary embodiment, the system detects a condition that indicates a change in an encryption algorithm for a plurality of encryption devices, where the plurality of encryption devices communicate data by encrypting the data with a first algorithm. Furthermore, the system can, in response to the detecting, trigger a software update for the plurality of encryption devices, where the software update indicates the plurality of encryption devices to use a second algorithm to encrypt data and that plurality of encryption devices subsequently communicates data by encrypting the data using the second algorithm.

In another embodiment, a method and apparatus of a system that rotates a key for a first and second encryption devices is described. In an exemplary embodiment, the system can receive an alert associated with one of the first and second encryption devices, wherein the first and second encryption devices use the key to encrypt data communicated between the first and second encryption devices. The system can further determine that the key rotation should occur using the alert and a plurality of artificial intelligence (AI) engines. In addition, the system can send a command to a first encryption, wherein the command indicates that the first encryption device should rotate the key and the first encryption device embeds an indication of the key rotation command in an encrypted packet sent to a second encryption device.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is an illustration of one embodiment of an encryption system.

FIG. 2 is a block diagram of one embodiment of a cryptographic architecture of a hardware or software encryption device network traffic.

FIG. 3 is a flow diagram of one embodiment of a process for online non-disruptive encryption algorithm update.

FIG. 4 is a flow diagram of one embodiment of a process for dynamic state-driven encryption key rotation.

FIG. 5 is a flow diagram of one embodiment of a decision process for encryption key rotation.

FIG. 6 illustrates one example of a typical computer system, which may be used in conjunction with the embodiments described herein.

### DETAILED DESCRIPTION

A method and apparatus of a system that improves the security of a network connected operational technology (“OT”), Internet of Things (“IoT”), or information technology (“IT”) device, collectively referred to hereafter as “device” is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

In one embodiment, the security of cryptographically protected information hinges on the strength, integrity, and security of both the cryptography algorithm and corresponding set of keys. Public key ciphers, for example, are at risk because of quantum computing. But even quantum-resistant algorithms will fail if broken by quantum-based cryptanalysis and if their associated encryption keys are not both secured and periodically rotated. In one embodiment, a “cryptoperiod” is defined as the time span over which a key is authorized or will remain in effect, where a given cryptoperiod may be of a random duration or scheduled based on time, amount of data sent, or other parameters.

The factors NIST outlines that affect the length of a cryptoperiod include:
1. The strength of the cryptographic mechanisms (e.g., the algorithm, key length, block size, and mode of operation).
2. The embodiment of the mechanisms (e.g., a FIPS 140 Level 4 implementation or a software implementation on a personal computer).
3. The operating environment (e.g., a secure limited-access facility, open office environment, or publicly accessible terminal).
4. Personnel turnover (e.g., of system administrators and CA system personnel).
5. The volume of data flow or the number of transactions.
6 The security life of the data.
7. Limitations required for algorithm usage (e.g., the maximum number of invocations to avoid nonce reuse).
8. The security function (e.g., data encryption, digital signature, key derivation, or key protection).
9. The re-keying method (e.g., keyboard entry, re-keying using a key-loading device where humans have no direct access to keys, or remote re-keying within a PKI).
10. The re-keying or key-derivation process used.
11. The number of nodes in a network that share a common key.
12. The number of copies of a key and the distribution of those copies.
13. The threat to the information from adversaries (e.g., their perceived technical capabilities and financial resources to mount an attack). and
14. The threat to the information from new and disruptive technologies (e.g., quantum computers).
   In one embodiment, once a key is compromised, the cryptoperiod terminates, and a new key and cryptoperiod are instantiated.

NIST notes that cryptographic algorithms may become vulnerable over time and provides a projected time frame for applying cryptographic protection where algorithms are disallowed by NIST, permitted only for legacy applications with use case provisions (e.g., only for verifying digital signatures), or allowed for applying protection and processing information that is already protected. A summary of security strength time frames follows in the table below.

| Security | | Through | | 2031 and | |
|---|---|---|---|---|---|
| Strength | | 2030 | | Beyond | |
| <112 | Applying | Disallowed | | Disallowed | |
| | protection | | | | |
| <112 | Processing | | Legacy | | Legacy |
| | | | use | | use |
| 112 | Applying | Acceptable | | Disallowed | |
| | protection | | | | |
| 112 | Processing | | Acceptable | | Legacy |
| | | | | | use |
| 128 | Applying | Acceptable | | Acceptable | |
| | protection | | | | |
| 128 | Processing | | Acceptable | | Acceptable |
| 192 | Applying | Acceptable | | Acceptable | |
| | protection | | | | |
| 192 | Processing | | Acceptable | | Acceptable |
| 256 | Applying | Acceptable | | Acceptable | |
| | protection | | | | |
| 256 | Processing | | Acceptable | | Acceptable |

A quantum compute breakthrough in codebreaking will create urgency in moving up these time frames and disallowing vulnerable algorithms. For example, and in one embodiment, Harvest Now Decrypt Later compounds this problem because Acceptable algorithms that are not quantum-resistant will allow attackers to harvest data today with the expectation of decrypting it in the future. Furthermore, what are initially considered quantum-resistant algorithms may be broken in the future, making quantum-resistant algorithmic agility even more important. Despite these concerns, there are no requirements or recommendations for algorithm rotation akin to the requirements for key rotation.

In one embodiment, the system can perform hitless hot swapping of ephemeral ciphers, hitless hot swapping of ephemeral cipher keys, or both hitless hot swapping of ephemeral ciphers and cipher keys, in response to manual commands, pre-configured schedules, the number of packets transmitted, the payloads of packets transmitted, the receipt of cyberattack threat levels, the receipt of critical alerts related to cybersecurity activity, the detection of physical or logical tampering with the encryptor or related networks or equipment including equipment enclosures, the prediction of threats by machine learning and artificial intelligence algorithms or agents, the receipt of threat advisories that are pulled, pushed, or polled, and other parameters, conditions, and activities.

In one embodiment, because encrypting devices will be encrypting every packet on a packet-by-packet basis with quantum-resistant symmetric encryption and FIPS 203 compatible quantum-resistant key exchange, the opportunity arises to implement lossless, hot-swappable encryption algorithms without disrupting packet transmission or interfering with the processes reliant on the ciphered payloads. Algorithms can even be swapped in the middle of current sessions because of the packet-level management of sessions by encryption device software. Just as frequency hopping has transformed the security of wireless communications, algorithmic hopping holds the promise of hugely complicating real-time code breaking especially for time-critical evanescent data like drone or machine control. In one embodiment, encrypting can mean encrypting of data, decrypting of data, and/or both. Thus, an encrypting device can encrypt data, decrypt data, or both.

In one embodiment, “threat-based hopping” can be provided in which hopping between encryption algorithms is dynamically adjusted based on the threat environment. While in one embodiment, the threat-based hopping is rotation of quantum-safe encryption algorithms, in alternate embodiments, the rotation can include a rotation of encryption algorithms in general, and/or a mix of non-quantum-safe and quantum-safe encryption algorithms. A threat environment can be established from one or more a multitude of sources—including any combination of operating system (OS) type, OS or application version, OS or application patch level, cryptographic security vulnerability, cyberattack threat level, a critical alert related to a cybersecurity activity, a detection of physical or logical tampering of a device (e.g., a physical, probing, or logical tampering of an encryptor, network device, device enclosure, and/or other type of physical/logical tampering), a prediction of threat (e.g., a prediction of a threat by machine learning algorithm/agent, artificial intelligence algorithms/agents, or another way to predict a threat), and/or receipt of a threat advisory (e.g., a threat advisory that is pulled, pushed, or polled) to determine when to hop. In one embodiment, threat-based hopping occurs on an out-of-band communication channel and does not require intercepting communications between an application and endpoints.

In one embodiment, a listener service can announce when a new cryptographic algorithm is to be loaded into one or more threads between client devices, sensors, and actuators and their respective controller(s) and/or server(s). In this embodiment, the new algorithm will be implemented instantaneously and loaded automatically with a new key provided to the remote client without breaking the session or data stream. This is possible because the encryption device and associated management software encodes the algorithm change together with the encrypted packet and in so doing notifies the target encryption device about a change to the encryption algorithm. Changing the algorithm together with the encrypted packet allows existing cryptographic sessions to be maintained and makes reboots and restarts unnecessary.

While in one embodiment, the existing key can become the first key for the new algorithm, in an alternate embodiment, a new key can be generated if a key rotation has been algorithmically determined to be necessary or is needed to accommodate technical requirements of the new encryption algorithm's key length or related parameters. If the existing key is used as the first key for the new algorithm, this key will be rotated following the first transmission by the new algorithm. No manual intervention or reboot will be required in the initial key rotation.

In one embodiment, an encryption configuration database can push down a library of algorithms to the encryption devices. For example, and in one embodiment, the information for each of the algorithms can include one or more of the algorithm names, the code behind the algorithm, any key requirements, or related relevant information—without being in-line to the handshake process. In this example, and embodiment, the information for each of the algorithms can be sent in a control channel that can be the same or different from the handshaking process. In one embodiment, this algorithm push can occur due to a variety of reasons. For example, and in one embodiment, the algorithm push can occur at specified or random time internals, when an algorithm is updated, in response to an external event like a threat, based on the output of machine learning or artificial intelligence models operating in parallel with ensemble and consensus, or a manual administrator command from an operator console, user interface, or the like, forwarded from a third-party solution such as a SOAR or SIEM, for another reason, and/or a combination therein. The algorithm push can establish an order and/or precedence of preferred algorithms. In one embodiment, by establishing an algorithm order and/or precedence, the encryption devices are enabled to function offline for extended periods of time without dependence during the handshake process on external devices, such as one or more additional computing devices, the function of which includes communicating which algorithm(s) to use. In this embodiment, the database should not be confused with an additional computing device, which device is not required for this invention to function. In one embodiment, a configuration database is used for maintaining configuration details around algorithms used, keys, and/or other information related to the encryption processes. While the database is not required at runtime, the details can be pushed to the device executing the encryption process so that this device can run disconnected from that database for extended periods of time.

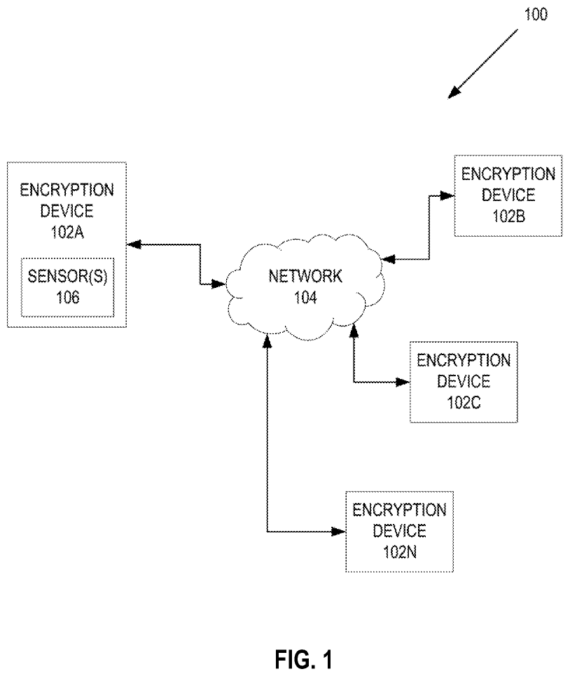

FIG. 1 is an illustration of one embodiment of a system 100 with an encryption device. In one embodiment, the system 100 includes multiple encryption devices 102A-N. In this embodiment, each of the encryption devices 102A-N can include a sensor, sensor 106.

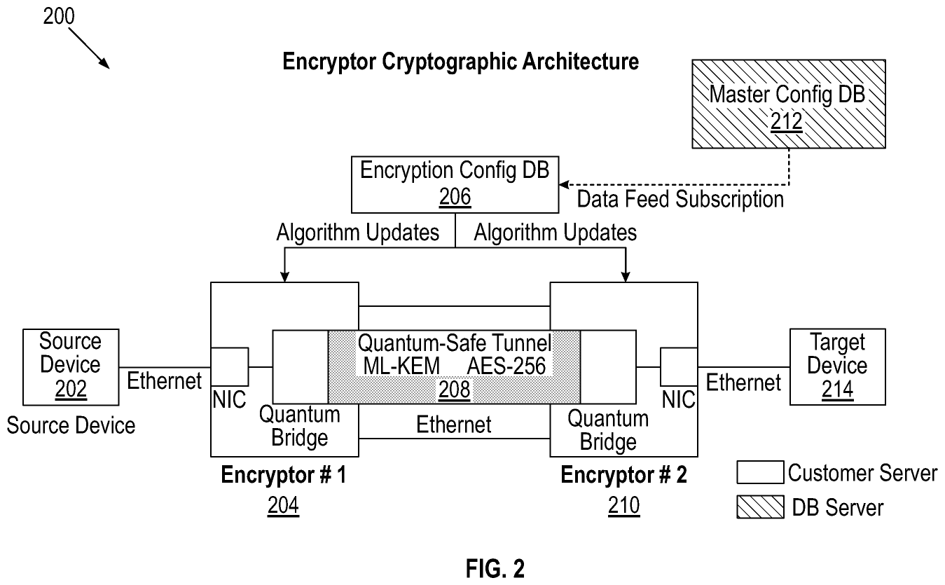

FIG. 2 is a block diagram of one embodiment of a cryptographic architecture 200 of a hardware encryption device. In FIG. 2, the cryptographic architecture 200 includes a source device 202 transmitting data to a target device 214. In one embodiment, the source device 202 is coupled to an encryption device 204. In this environment, the source device 202 can be coupled to encryption device 204 via a wired or wireless Ethernet connection, or another type of network data connection. In one embodiment, the encryption device 204 establishes a quantum-resistant tunnel with another encryption device 210. In this embodiment, a quantum-resistant algorithm including but not limited to ML-KEM AES-256 quantum-resistant tunnel can be established via an Ethernet connection between the two encryption devices 204 and 210. Furthermore, the encryption device 210 is coupled to the target device 214 via a wired or wireless Ethernet connection, or another type of network data connection. As discussed above, the cryptographic algorithm used to encrypt the data for the quantum-resistant tunnel 208 can change in response to different conditions. For example, and in one embodiment, the cryptographic algorithm used to encrypt the data for the quantum-resistant tunnel 208 can change due to: manual commands; pre-configured schedules; number of packets transmitted; payloads of packets transmitted; receipt of cyberattack threat levels; receipt of critical alerts related to cybersecurity activity; the detection of physical or logical tampering with the encryptor or related networks or equipment including equipment enclosures, prediction of threats by machine learning and artificial intelligence algorithms or agents, receipt of threat advisories that are pulled, pushed, or polled, and/or other parameters, conditions, and activities. In this embodiment, an encryption configuration database 206 can send out algorithm updates to the two encryption devices 204 and 210. In one embodiment, the encryption configuration database 206 can receive the algorithm configurations from a primary configuration database 212 (or another source), where the primary configuration database 212 sends a data feed subscription of algorithm updates to the encryption configuration database 206. In one embodiment, the encryption devices 204 and 210 and the encryption configuration database 206 can be coupled with the customer server and the primary configuration database 212 can be stored on a third-party remote secure server. In one embodiment, configuration databases 206 and 212 may not both be required if both were to be hosted on the customer site since primary configuration database 212 maintains a central repository of standard quantum-resistant encryption algorithms.

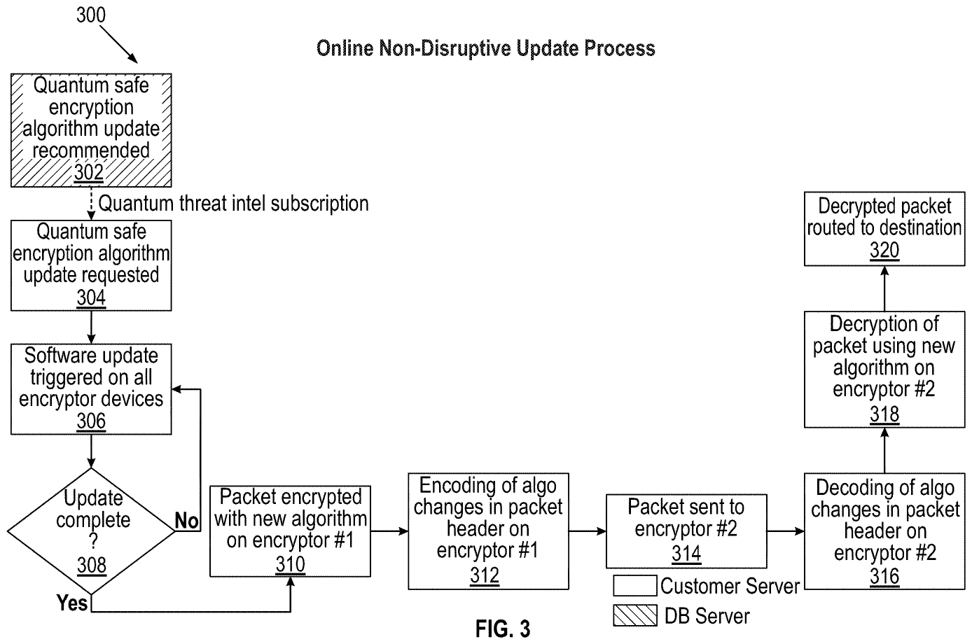

FIG. 3 is a flow diagram of one embodiment of a process 300 for online non-disruptive update. In FIG. 3, process 300 begins by determining that a quantum-resistant encryption algorithm update is recommended at block 302. In one embodiment, process 300 determines that a threat-based encryption algorithm update is recommended based on a detected or received threat as described above. At block 304, process 300 requests a quantum-resistant encryption algorithm update. Process 300 triggers a quantum-resistant encryption algorithm update on the encryption devices at block 306. Process 300 determines if the quantum-resistant encryption algorithm update is complete at block 308. If the software update is not completed, execution proceeds to block 306 above. If the quantum-resistant encryption algorithm update is complete, at block 310, process 300 encrypts a packet with a new algorithm on the source encryption device. In one embodiment, the source encryption device is the encryption device that is receiving data from a source device that is to be transmitted to a destination device. At block 312, process 300 encodes the algorithmic changes in a packet header for each of the packets received from the source device at the source encryption device. Process 300 sends the encoded packets to the destination device at block 314. At block 316, process 300 decodes the algorithmic changes in a packet header at the destination encryption device. At block 318, process 300 decrypts packets using the new algorithm on the destination encryption device. Process 300 routes the decrypted packet to the destination device at block 320. For example, and in one embodiment, block 302 can be performed by the secure computing device. Blocks 310, 312, and 314 can be performed by the source encryption device. Blocks 316, 318 and block 320 can be performed by the destination encryption device. Blocks 304, 306, and 308 may be performed by either the source or destination encryption devices or both the source and destination encryption devices.

In one embodiment, in addition to threat-based algorithm rotation being used to secure a network and/or devices in the network, threat-based key rotation can be performed to secure the network and/or devices in the network The security of cryptographically protected information hinges on the strength, integrity, and security of both the cryptography algorithm and its key. Even quantum-resistant algorithms will fail if their associated encryption keys are not both secured and rotated from time-to-time.

In one embodiment, once a key is compromised, the cryptoperiod terminates, and a new key and cryptoperiod are instantiated. There is a cost to key rotation in terms of labor, CPU utilization, and the disruption associated with stopping and restarting devices, threads, tunnels, and applications.

A glaring gap in the fourteen cryptoperiod NIST factors are guidelines for adaptively and randomly rotating keys based on various conditions that may arise in a system. For example, there are no guidelines to rotate keys due to an elapsed time between key rotations, the real-time threat environment including insider threats, the impact of compromised keys that are being actively exploited but have not yet been detected, equipment tampering, key memory repository probing, and/or other factors. Knowing that a key has a lower chance of being compromised if the key is randomly changed as opposed to a higher likelihood of being compromised in the presence of detected threats, volume and type of traffic, concerning security telemetry (Endpoint Detection and Response (EDR), Extended Detection and Response (XDR), Managed Detection and Response (MDR), Protection, Network Detection and Response (NDR), Network Performance Monitoring (NPM), and/or Security Information and Event Management (SIEM)), a change in the customer's security posture, and other situational parameters means that the NIST factors alone are not sufficient to protect a cryptoperiod.

In one embodiment, risk-based situational awareness can be achieved based on a real-time AI Randomizer (collective referred to as “AIR”) which determines when to rotate keys based on randomized minimum and maximum rotation intervals that are modulated by a consensus among multiple AI engines that assess detected threats, risk of compromise, detection of unusual traffic, and detection of anomalous activity, security telemetry, security posture, other real-time situational parameters, an AI-generated playbook, and/or a combination therein. In this embodiment, AIR can be used alone or by supplementing rekeying factors that might already be in use, but which have gaps in their timely implementation or effectiveness against certain threats. In one embodiment, AIR performs the key rotation determination based on the criticality of situationally aware alerts received from EDR, XDR, MDR, NDR, NPM, and/or SIEM systems, thereby avoiding situationally-unaware rote schedules that may needlessly interfere with operations without any commensurate security benefits. In one embodiment, there is a receiver process that listens for alerts from third-party cybersecurity solutions like SIEM, XDR, NDR, and/or other cybersecurity solutions. AIR analyzes these alerts at runtime and makes a determination if a key (and/or encryption algorithm) needs to be rotated based on these alerts. For example, a third-party solution that is scanning individual hosts could determine that there is a ransomware attack moving through the organization. This information would be sent to the receiver, where AIR takes action to rotate keys and/or algorithms to make it more difficult for an attacker to intercept data, keys, and/or determine what encryption algorithms are being used. In a further embodiment, key and/or algorithm rotation can occur as a result of an AI-generated playbook as part of a remediation process as described in U.S. patent application Ser. No. 19/673,323, entitled “SYSTEMS AND METHODS OF NETWORK SECURITY PLAYBOOK CREATION AND UTILIZATION”, filed on May 11, 2026, which is incorporated herein by reference. In one embodiment, the AI-generated playbook can include a section that indicates that a key and/or algorithm should be rotated.

In one embodiment, AIR can utilize one or more ML models to determine when to initiate a key and/or algorithm rotation. In this embodiment, the ML model(s) can be trained on the baseline operational (and/or other) customer data. The customer data can be the baseline data indicating the normal operation of the devices and/or the network. For example, and in one embodiment, the ML models can be trained on electrical signals of sensors in the network, network activity, operational data of devices in the network, and/or other data. The ML models can be used to infer threat in the network and/devices in the network. While in one embodiment, an AIR service can be run for one or more encryption devices in a device that is separate and distinct from the encryption devices whose keys are being cycled, in an alternative embodiment, the AIR service can be run on the encryption devices whose keys are being cycled provided that they have sufficient processing resources.

In one embodiment, the encryption devices control and encryption software implements user-defined minimum and maximum key rotation internals, between which the AIR assesses threat risk and extends or shortens the key rotation period. In this embodiment, the key rotation commands are embedded together with encrypted packets, thereby notifying the target encryption device hardware about an upcoming key rotation event. This process can occur below the session and application layers, which are unaware and unaffected by the rekeying process. This non-disruptive abstraction ensures that existing keys are rotated without disrupting active sessions or applications, and that device, process, and application reboots or restarts are unnecessary.

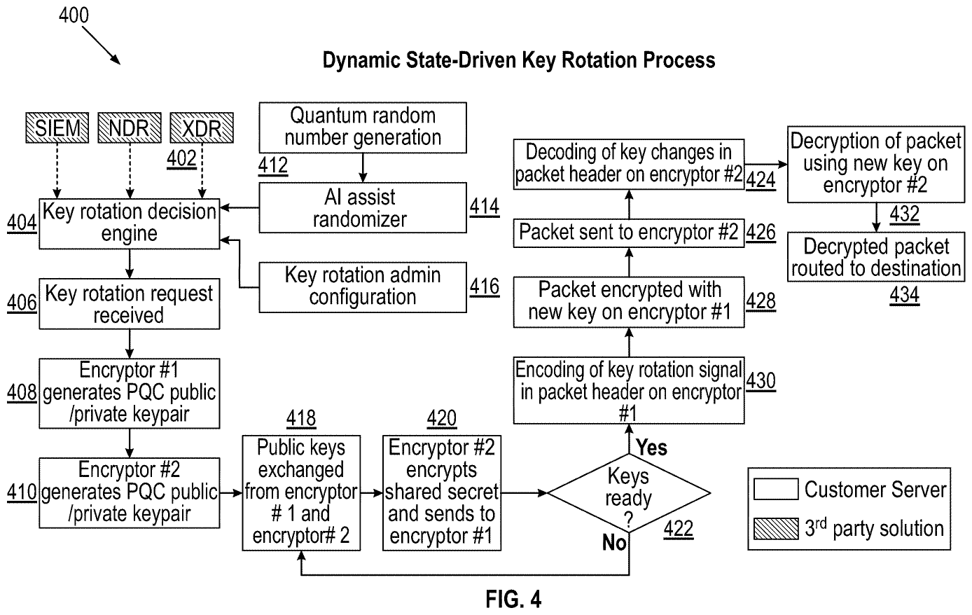

FIG. 4 is a flow diagram of one embodiment of a process 400 for dynamic state-drive key rotation. In FIG. 4, process 400 begins by receiving configuration data from network security processes at block 402. In one embodiment, the network security processes can include SIEM, NDR, XDR, and/or other sources. At block 404, process 1000 performs a key rotation decision. In one embodiment, the key rotation decision can be performed by a key rotation decision engine. In this embodiment, process 400 performs a quantum random number generation 412 that is used for an AI assist randomizer 414 that can be fed into the key rotation decision engine 404. In addition, a key rotation administration configuration 416 can also feed into the key rotation decision engine 404.

At block 406, process 400 receives a key rotation request. At block 408, process 400 generates a post-quantum cryptography (PQC) public/private keypair at a source encryption device. At block 410, process 400 generates a PQC public/private key pair at a destination encryption device. At block 418, process 400 exchanges public keys from the source encryption device and the destination encryption device. At block 420, process 400 encrypts a shared secret from the destination encryption device and sends the shared secret to the source encryption device. At block 422, process 400 determines if the keys are ready. If the keys are ready, at block 430, process 400 encodes a key rotation schedule in a packet header on the source encryption device. At block 428, process 400 encrypts the packet with the new key on the source encryption device. Process 400 sends the encrypted packet to the destination encryption device at block 426. At block 424, process 400 decodes key changes in the packet header on the destination encryption device. Process 400 decrypts the packet using the new key on the destination encryption device at block 432. At block 434, process 400 routes the decrypted packet to the destination (e. g., the destination device). If the keys are not ready at block 422, execution proceeds to block 418 above.

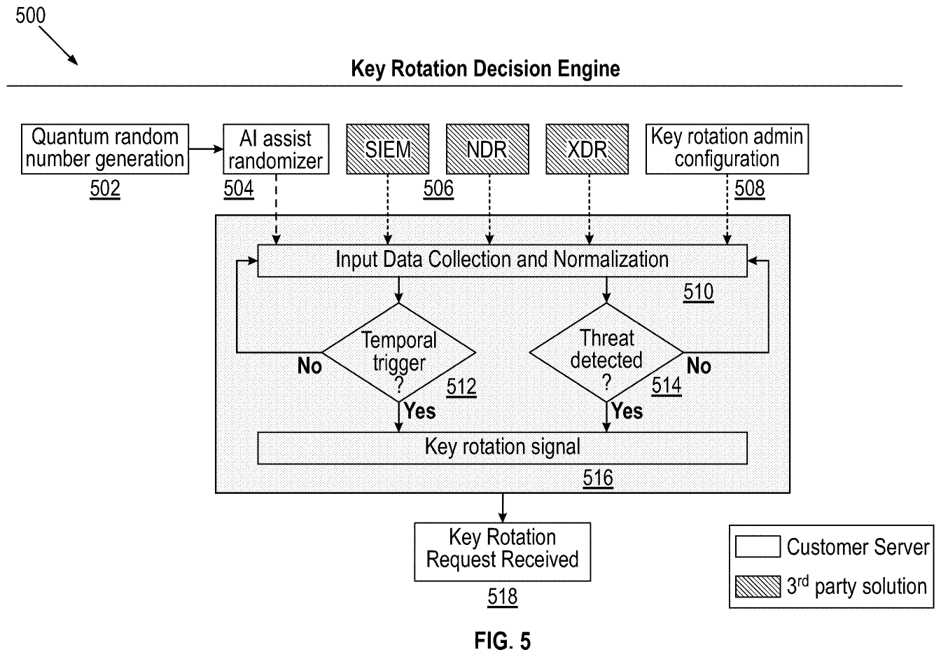

FIG. 5 is a flow diagram of one embodiment of a process 500 for encryption key rotation decision. FIG. 5, process 500 performs quantum random key generation at block 502. At block 504, process 500 performs AI assist randomizer. The results of the AI assist randomizer can be forwarded to block 510 below. At block 506, real-time threat data from network security processes can be forwarded to block 510 below. In one embodiment, the network security processes can be SIEM, NDR, XDR, and/or another type of network management or security process that produces actionable signals. At block 508, process 500 performs a key rotation administration configuration.

At block 510, process 500 performs input data collection and normalization. In one embodiment, process 500 receives the outputs of the AI assist randomizer at block 504, the network management processes data forwarding at block 506, and the data from the key rotation administration configuration at block 508. At block 512, process 500 determines if a temporal trigger is detected. If not, execution proceeds to block 510 above. If a temporal trigger is detected, execution proceeds to block 516 below. At block 514, process 500 determines if a threat is detected. If no threat is detected, execution proceeds to block 510 above. If a threat is detected, execution proceeds to block 516 below.

At block 516, process 500 generates a key rotation signal and sends the key rotation signal to the relevant devices. In one embodiment, process 500 sends the key rotation signal to one or more encryption devices in a network. At block 518, process 500 receives the key rotation signal.

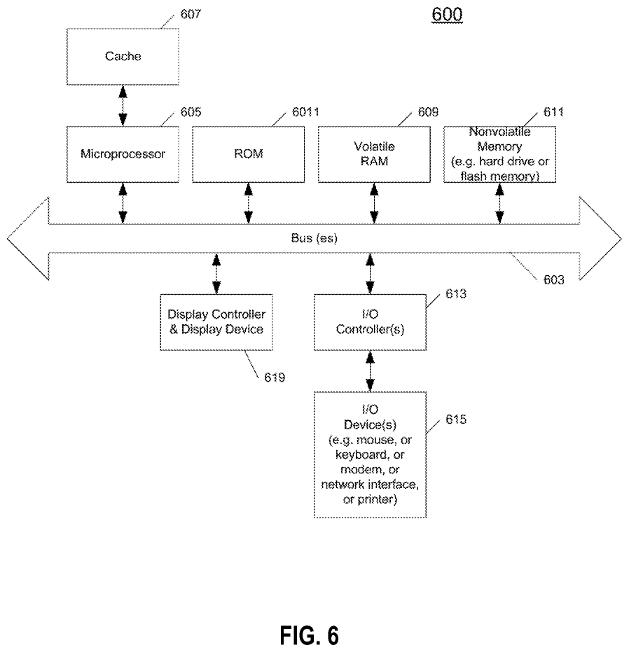

FIG. 6 shows one example of a data processing system 600, which may be used with one embodiment of the present invention. For example, the system 600 may be implemented as a system that includes device 102A as illustrated in FIG. 1 above. Note that while FIG. 6 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 6, the computer system 600, which is a form of a data processing system, includes a bus 603 which is coupled to a microprocessor(s) 605 and a ROM (Read Only Memory) 601 and volatile RAM 609 and a non-volatile memory 611. The microprocessor 605 may include one or more CPU(s), GPU(s), a specialized processor, and/or a combination thereof. The microprocessor 605 may retrieve the instructions from the memories 607, 609, 611 and execute the instructions to perform operations described above. The bus 603 interconnects these various components together and also interconnects these components 605, 607, 609, and 611 to a display controller and display device 619 and to peripheral devices such as input/output (I/O) devices which may be mice, keyboards, modems, network interfaces, printers and other devices which are well known in the art. Typically, the input/output devices 615 are coupled to the system through input/output controllers 613. The volatile RAM (Random Access Memory) 609 is typically implemented as dynamic RAM (DRAM), which requires power continually in order to refresh or maintain the data in the memory.

The mass storage 611 is typically a magnetic hard drive or a magnetic optical drive or an optical drive or a DVD RAM or a flash memory or other types of memory systems, which maintain data (e.g., large amounts of data) even after power is removed from the system. Typically, the mass storage 611 will also be a random access memory although this is not required. While FIG. 6 shows that the mass storage 611 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 603 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “determining,” “setting,” “adjusting,” “communicating,” “sending,” “receiving,” “resetting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to change an algorithm for encryption, the method comprising:
detecting a condition that indicates a change in an encryption algorithm for a plurality of encryption devices, wherein the plurality of encryption devices communicate data by encrypting the data with a first algorithm;
in response to the detecting:
triggering a software update for the plurality of encryption devices, wherein the software update indicates the plurality of encryption devices to use a second algorithm to encrypt data and that plurality of encryption devices subsequently communicates data by encrypting the data using the second algorithm.

2. The machine-readable medium of claim 1, wherein at least one of the plurality of encryption devices encodes an algorithmic change to the second algorithm in a packet to be communicated with another one of the plurality of encryption devices.

3. The machine-readable medium of claim 2, wherein the encoded algorithm change is stored in a header of the placket.

4. The machine-readable medium of claim 1, wherein the condition is one or more of operating system (OS) type, OS or application version, OS or application patch level, cryptographic security vulnerability, cyberattack threat level, a critical alert related to a cybersecurity activity, a detection of physical or logical tampering of a device, a prediction of threat, or receipt of a threat advisory.

5. The machine-readable medium of claim 1, further comprising:
downloading to each of the plurality of encryption devices a set of algorithms that can be used for the change in algorithms.

6. The machine-readable medium of claim 5, wherein the set of algorithms includes an order of the algorithms for the change in algorithms.

7. A non-transitory machine-readable medium having executable instructions to cause one or more processing units to perform a method to rotate a key for a first and second encryption devices, the method comprising:
receiving an alert associated with one of the first and second encryption devices, wherein the first and second encryption devices use the key to encrypt data communicated between the first and second encryption devices;
determining that the key rotation should occur using the alert and a plurality of artificial intelligence (AI) engines;
sending a command to a first encryption, wherein the command indicates that the first encryption device should rotate the key and the first encryption device embeds an indication of the key rotation command in an encrypted packet sent to a second encryption device.

8. The machine-readable medium of claim 7, further comprising:
receiving a minimum key rotation schedule; and
altering the minimum key rotation schedule in response to the determination that the key rotation should occur.

9. The machine-readable medium of claim 7, further comprising:
receiving a maximum key rotation schedule; and
altering the maximum key rotation schedule in response to the determination that the key rotation should occur.

10. The machine-readable medium of claim 7, wherein the alert is received from a cybersecurity system.

11. The machine-readable medium of claim 10, wherein the cybersecurity system is one of Endpoint Detection & Response, Extended Detection & Response, Managed Detection & Response, Network Detection & Response, Network Performance Monitoring, and Security Information & Event Management cybersecurity systems.

12. The machine-readable medium of claim 7, wherein the alert is one of a detected threat, risk of compromise, detection of unusual traffic, detection of anomalous activity, security telemetry, and security posture.

13. A method to change an algorithm for encryption, the method comprising:
detecting a condition that indicates a change in an encryption algorithm for a plurality of encryption devices, wherein the plurality of encryption devices communicate data by encrypting the data with a first algorithm;
in response to the detecting:
triggering a software update for the plurality of encryption devices, wherein the software update indicates the plurality of encryption devices to use a second algorithm to encrypt data and that plurality of encryption devices subsequently communicates data by encrypting the data using the second algorithm.

14. The method of claim 13, wherein at least one of the plurality of encryption devices encodes an algorithmic change to the second algorithm in a packet to be communicated with another one of the plurality of encryption devices.

15. The method of claim 14, wherein the encoded algorithm change is stored in a header of the packet.

16. The method of claim 13, wherein the condition is one or more of operating system (OS) type, OS or application version, OS or application patch level, cryptographic security vulnerability, cyberattack threat level, a critical alert related to a cybersecurity activity, a detection of physical or logical tampering of a device, a prediction of threat, or receipt of a threat advisory.

17. The method of claim 13, further comprising:
downloading to each of the plurality of encryption devices a set of algorithms that can be used for the change in algorithms.

18. The method of claim 17, wherein the set of algorithms includes an order of the algorithms for the change in algorithms.

19. A method to rotate a key for a first and second encryption devices, the method comprising:
receiving an alert associated with one of the first and second encryption devices, wherein the first and second encryption devices use the key to encrypt data communicated between the first and second encryption devices;
determining that the key rotation should occur using the alert and a plurality of artificial intelligence (AI) engines;
sending a command to a first encryption, wherein the command indicates that the first encryption device should rotate the key and the first encryption device embeds an indication of the key rotation command in an encrypted packet sent to a second encryption device.

20. The method of claim 19, further comprising:
receiving a minimum key rotation schedule; and
altering the minimum key rotation schedule in response to the determination that the key rotation should occur.
